(19) United States
(12) Patent Application Publication
(10) Pub. No.: US 2020/0309705 A1
(43) Pub. Date: Oct. 1, 2020

(54) ANALYSIS ASSEMBLY SUPPORTING AN ANALYSIS CHIP

(71) Applicant: HEWLETT-PACKARD DEVELOPMENT COMPANY, L.P., Sping, TX (US)

(72) Inventors: Caitlin DeJONG, Palo Alto, CA (US); Anita ROGACS, San Diego, CA (US)

(73) Assignee: Hewlett-Packard Development Company, L.P., Spring, TX (US)

(21) Appl. No.: 16/628,745

(22) PCT Filed: Jul. 13, 2017
(86) PCT No.: PCT/US2017/041967

§ 371 Date: Jan. 6, 2020

(51) Int. Cl. G01N 21/65; G01N 1/40; B01L 3/00; B01L 9/06

(52) U.S. Cl. CPC G01N 21/658; B01L 9/06; B01L 3/50853; G01N 1/405

(57) ABSTRACT

An analysis assembly is provided. The analysis assembly includes an analysis chip disposed on a supporting platform aligned in an x-y plane, wherein an active surface of the analysis chip is aligned along a z-axis opposite the supporting platform. A mounting assembly joined to the supporting platform is configured to hold the analysis chip in an analysis vessel, and wherein the z-axis is in alignment with a longitudinal axis of the analysis vessel.

### BACKGROUND

Analysis chips are devices that have a substrate that supports a surface designed to be reactive with analyte molecules. For example, analysis chips may include surfaces that adsorb, absorb, or react with the analyte molecules to provide a change that may be determined by analytical techniques, such as spectroscopy. However, current methods for sample preparation and incubation for analysis chips, such as spectroscopic chips, are time consuming. Further, the methods may have problems with cross contamination and variability in incubation time. For example, single analysis chips may be transferred between tubes of different liquids or solvents using forceps, posing a potential for cross-contamination. To avoid cross-contamination, separate forceps are generally needed for each condition or washed between conditions. The methods may also be time consuming, as the analysis chips need to be carefully removed from each tube and transferred to a new one, which does not allow for batch processing. Thus, the use of multiple analysis chips may result in variation in incubation time, as analysis chips transferred first may be in liquids longer than analysis chips transferred last.

### DESCRIPTION OF THE DRAWINGS

Certain exemplary embodiments are described in the following detailed description and in reference to the drawings.

FIG. 1 is a drawing of an example of an analysis chip for spectroscopic analysis being probed by an excitation beam of electromagnetic radiation.

FIG. 2 is a drawing of an example of an analysis chip used for surface enhanced luminescence.

FIGS. 3(A) to 3(C) are drawings of an example of an analysis assembly supporting an analysis chip.

FIG. 4 is a schematic drawing of an example of an analysis assembly placed in a test vessel.

FIG. 5 is a schematic drawing of another example of an analysis assembly supporting an analysis chip.

FIG. 6 is a schematic drawing of an example of a method for preparing a sample on an analysis chip supported by an analysis assembly.

FIG. 7 is a drawing of an example of a caddy strip of analysis assemblies supporting multiple analysis chips.

FIG. 8 is a schematic drawing of an example of a caddy strip used to prepare multiple samples on analysis chips simultaneously.

FIG. 9 is a drawing of an example of a strip tube basket supporting multiple analysis chips.

FIG. 10 is a schematic drawing of a strip tube basket used to prepare multiple samples on analysis chips simultaneously.

FIG. 11 is a drawing of an example of an analysis assembly that uses a column to support an analysis chip in a test vessel.

FIG. 12 is a schematic drawing of an example of a method for preparing a sample on an analysis chip supported by an analysis assembly including a column.

FIGS. 13(A) through 13(D) are schematic diagrams indicating the use of an analysis assembly in a test vessel and column.

FIG. 14 is a drawing of an analysis assembly supporting an analysis chip used in a test vessel with a column.

FIGS. 15(A) through 15(D) are schematic diagrams indicating the use of an analysis assembly in a test vessel and column.

FIG. 16 is a drawing of an analysis assembly supporting an analysis chip used in a test vessel that can hold multiple increments of test fluids.

FIG. 17 is a schematic drawing of an example of a method for preparing a sample on analysis chip supported by an analysis assembly in a larger test vessel 1602 that can hold multiple increments of test fluids.

FIG. 18 is a process flow diagram of a method for preparing a sample on an analysis chip supported by an analysis assembly.

### DETAILED DESCRIPTION

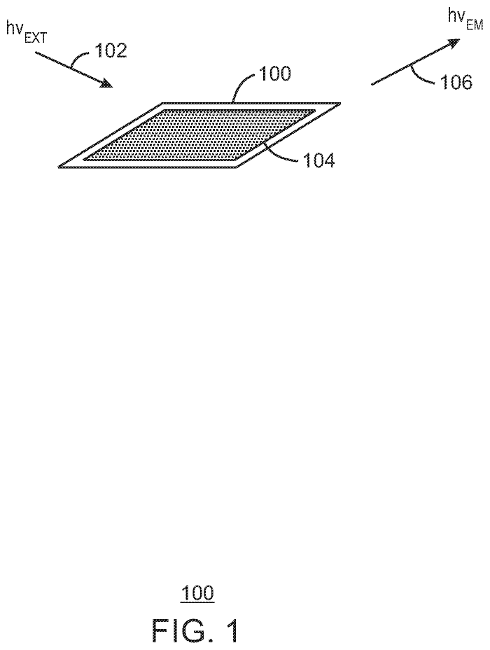

Analysis assemblies, described in examples herein, include a supporting platform aligned in an x-y plane to hold an analysis chip aligned along a z-axis. The analysis chip is discussed with respect to FIG. 1. An active surface of the analysis chip may be positioned opposite to the supporting platform. A mounting assembly may be joined to the supporting platform, wherein the mounting assembly is configured to hold the analysis chip in an analysis vessel so that the z-axis is in alignment with longitudinal axis of the analysis vessel, for example, pointing upwards.

In some examples, the supporting platform may include a chip holder. In the chip holder, in analysis chip may slide into a slot along the x-y plane. In other examples, the supporting platform may be a mesh configured to support the analysis chip.

The mounting assembly may include one or more L-shaped brackets configured to engage the upper lip of an analysis vessel and hold the supporting platform in the analysis vessel. In some examples, the mounting assembly may include an open tubular cylinder with a mesh affixed to one end, and a lip at the opposing end. The lip may be sized to engage the upper lip of the analysis vessel to hold the cylinder in place within the analysis vessel.

The analysis vessel may include any number of test vessels or tubes. For example, the analysis vessel may be a micro-centrifuge tube, a multi-well test plate, or a multi-well cell culture plate, among many others. The portion of the mounting assembly that engages with the upper lip of the analysis vessel allows the analysis assembly to easily be removed from the analysis vessel, for example, to be moved to new analysis vessel.

FIG. 1 is a drawing of an example of an analysis chip 100 for spectroscopic analysis being probed by an excitation beam 102 of electromagnetic radiation. The excitation beam 102 interacts with an active surface 104 that may hold analyte species. In response to the excitation beam 102, radiation may be emitted from the active surface 104. The characteristics of the emitted radiation 106 may depend, at least in part, on the analyte species, providing information about the analyte species. The active surface 104 may include any number of absorbent, adsorbent, or chemically reactive materials that can trap or react with the analyte species.

The excitation beam 102 and the emitted radiation 106 may be at wavelength ranges extending from the near ultraviolet to the near infrared. For example, this may cover a wavelength range from about 150 nanometers (nm) to about 2,500 nm. Accordingly, an analysis chip 100 may be used for surface enhanced spectroscopy (SES), such as surface enhanced Raman spectroscopy (SERS), or other surface enhanced luminescence (SEL) techniques, such as fluorimetry. Further other spectroscopic techniques, such as transflectance, which uses light that is both transmitted and reflected, may be used.

The analysis assemblies described herein are not limited to spectroscopic analysis chips, but may be used with any number of other techniques. For example, the analysis assemblies may be used to hold chips for monoclonal antibody analysis, colorimetry analysis, and the like.

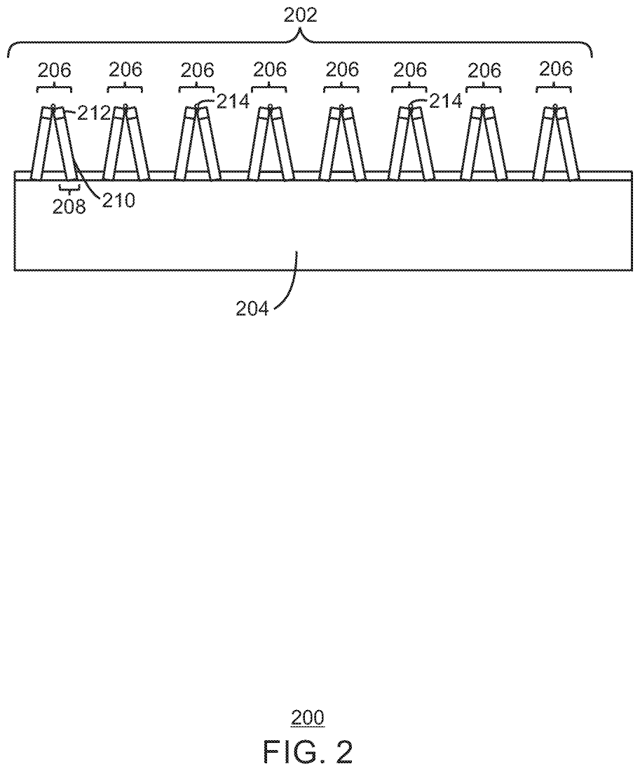

FIG. 2 is a drawing of an example of an analysis chip 200 used for surface enhanced luminescence. In this example, the active surface 104, as described with respect to FIG. 1, may include surface structures 202 that may be used for surface enhanced Raman spectroscopy (SERS). The analysis chip 200 includes a substrate 204 supporting the surface structures 202. The substrate 204 may be a polymeric material, such as a polyamide, a polyethylene, polypropylene, or other polymers or copolymers. In some examples, the substrate may be an inorganic material, such as silicone, glass, quartz, silicon nitride, sapphire, aluminum oxide, diamond, and the like.

The surface structures 202 include a number of collapsed groups 206 that each contain a number of flexible columnar structures 208, for example, from two to five flexible columnar structures 208. Each flexible columnar structure 208 may include a flexible column 210, for example, formed from a polymeric material, such as polyacrylates, polysilanes, polycarbonates, and the like, using a die to form the structures. Other techniques may also be used.

A metal cap 212 may be formed over the apex of each of the flexible columns 210, for example, by vapor deposition, among other techniques. The composition of the metal cap 212 may be selected so that surface plasmons are generated within the wavelength ranges of the excitation beam 102, described with respect to FIG. 1. For example, the metal cap 212 may include gold, silver, copper, or alloys thereof. Other metals may be used in the metal cap 212, such as aluminum, titanium, or other metals.

Initially, the flexible columns 210 may be vertical, with the metal caps 212 separated. A solution, for example, including an analyte molecule 214, may be applied over the surface of the analysis chip 200. The solution may be allowed to slowly evaporate, providing a capillary force that pulls the flexible columns 210 into proximity with each other. Analyte molecules 214 may be adsorbed by the metal caps 212. As a result, the emitted radiation 106 may be amplified by the increased number of metal caps in proximity to the analyte molecules 214, as a result in the increase in the excitation of surface plasmons in proximity to the analyte molecules 214. It can be noted that not every analyte molecule 214 is labeled in FIG. 2, so as to simplify the figure. It can be noted that to simplify the diagram, not every flexible columnar structure 208, flexible column 210, metal cap 212, or analyte molecules 214 is labeled.

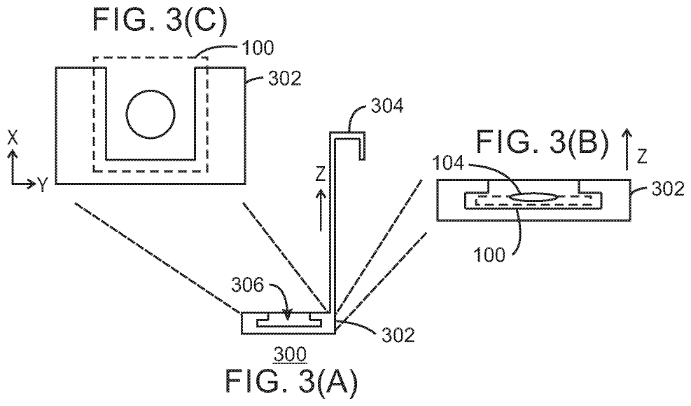

FIGS. 3(A) to 3(C) are drawings of an example of an analysis assembly 300 supporting an analysis chip 100. Like numbered items are as described with respect to FIG. 1. In this example, the analysis assembly 300 is made up of a supporting platform 302 and a mounting assembly 304. The mounting assembly 304 may be in an L-shape to engage the sides of a test vessel. Other shapes may be used, depending on the configuration of the test vessel.

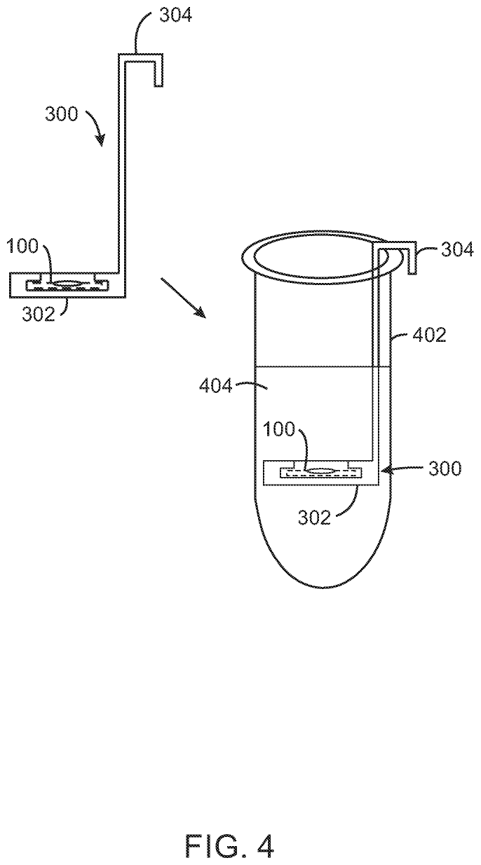

The supporting platform 302 may have a slot 306 designed to allow an analysis chip 100 to be inserted, for example, from the side, as shown in the side view of FIG. 3(B). The supporting platform 302 then holds the analysis chip 100 so that the active surface including the active surface 104 faces upwards along the z-axis in the direction of the mounting assembly 304, as shown in the top view of FIG. 3(C). This allows the active surface to be exposed to solutions introduced into a test vessel from above, for example, as described with respect to FIG. 4.

FIG. 4 is a schematic drawing of an example of an analysis assembly 300 placed in a test vessel 402. Like numbered items are as described with respect to FIGS. 1 and 3. In this example, the test vessel 402 contains a sample preparation fluid 404. The analysis assembly 300 may be lowered into the test vessel 402 with the supporting platform 302 immersed in the preparation fluid 404. The supporting platform 302 holds the analysis chip 100 in the preparation fluid 404 with the active surface pointed upwards into the preparation fluid 404. The mounting assembly 304 may be affixed over the lip of the test vessel 402 to hold the supporting platform 302 in place.

The analysis chip 100 may remain in the sample preparation fluid 404 for a suitable incubation period, for example, 30 seconds, 1 minute, 5 minutes, or longer, depending on the chemistry used for the preparation of the analysis chip 100. The analysis assembly 300 may then be removed from the test vessel 402, for example, being lifted out by the mounting assembly 304. The analysis assembly 300 may then be moved to other test vessels, for example, allowing excess preparation fluids to drain off between each treatment, decreasing the possibility of cross-contamination.

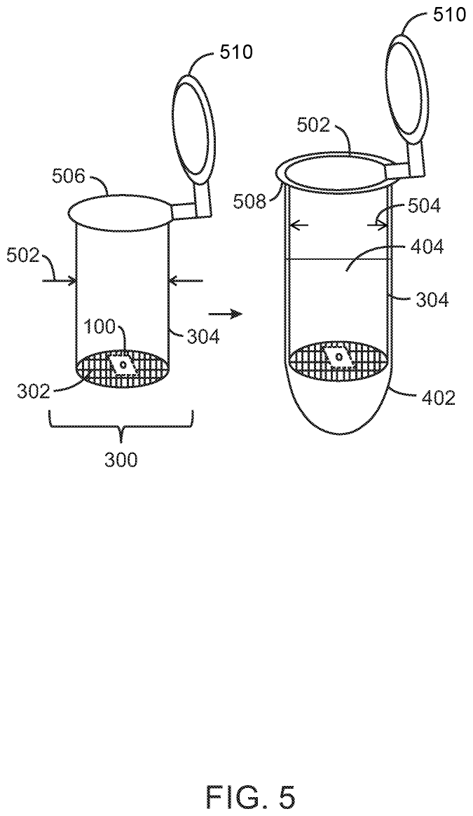

The mounting assembly 304 is not limited to a single supporting device, but may have multiple supporting devices placed around the supporting platform 302. This may allow the analysis assembly 300 to be used in a test vessel 402 that is subject to centrifugation. Further, as described herein, the analysis assembly 300 is not limited to the configuration shown, but may use other configurations, such as described with respect to FIG. 5.

FIG. 5 is a schematic drawing of another example of an analysis assembly 300 supporting an analysis chip 100. Like numbered items are as described with respect to FIGS. 1, 3, and 4. In this example, the supporting platform 302 is a mesh joined to the bottom of the mounting assembly 304. The mounting assembly 304 is a tubular structure, or open tube, with an outer diameter 502 that is smaller than the inner diameter 504 of the test vessel 402. This allows the mounting assembly 304 to be inserted into the test vessel 402. The analysis chip 100, resting on or mounted to the mesh, is then immersed in the preparation fluid 404.

A lip 506 at the top of the mounting assembly 304 may engage the top rim 508 of the test vessel 402, holding the analysis assembly 300 in place within the test vessel 402 during an incubation period. After the incubation period is completed, the analysis assembly 300 may be removed from the test vessel 402, allowing the preparation fluid 404 to drain through the mesh of the supporting platform 302. The analysis assembly 300 may have a cap 510, for example, to close the analysis assembly 300 during an incubation period.

The examples of the analysis assembly 300 described with respect to FIGS. 3 and 5 may be made using any number of different techniques, depending on the material. For example, 3D printing may be used to generate the analysis assembly 300 from polymers, such as polyacrylates, and the like. Other techniques that may be used include injection molding, blow molding, and the like.

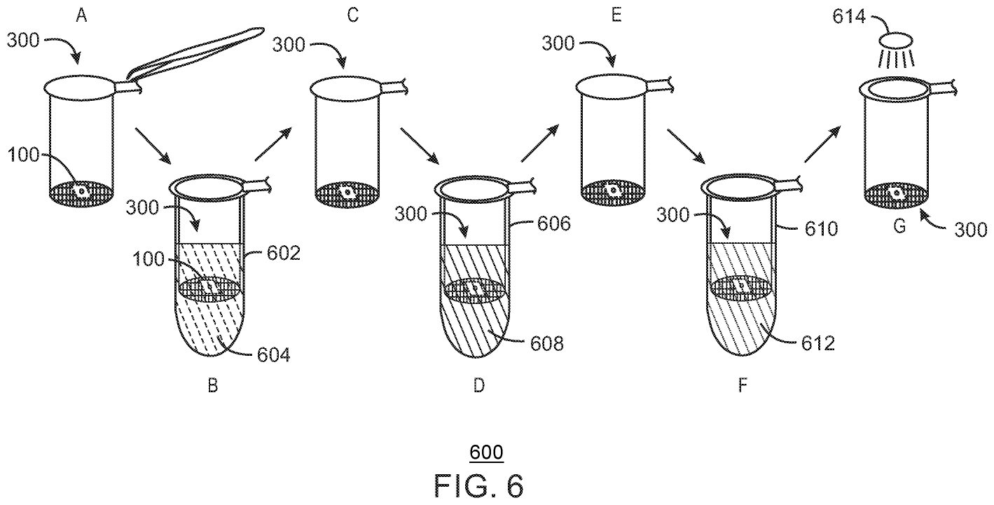

FIG. 6 is a schematic drawing of an example of a method 600 for preparing a sample on an analysis chip 100 supported by an analysis assembly 300. Like numbered items are as described with respect to FIGS. 1 and 3. The number of solutions and the steps, in this example are merely a representative example and may change depending on the chemistry of the analysis chip 100 and preparation procedure.

As described herein, the preparation procedure of the method may be for an analysis chip 100 using for a surface enhanced luminescence analysis, as described with respect to FIGS. 1 and 2. The analysis chip 100 may be inserted and removed from preparation solutions in a sequential fashion, using the mounting assembly 302.

The method 600 begins at point A when analysis assembly 300 including an analysis chip 100 is placed in an analysis vessel 602, as indicated at point B. The analysis vessel 602 includes a preparation solution 604, which may include analyte molecules. The analysis assembly 300 is then removed from the analysis vessel 602, and the preparation solution 604 drains out through the mesh.

The analysis assembly 300 may then be inserted into a second analysis vessel 606 that holds a second preparation solution 608, as indicated at point D. The analysis assembly 300 is then removed from the second analysis vessel 606, as indicated at point E, and allowed to drain. The analysis assembly 300 may then be inserted into third analysis vessel 610 that holds a third preparation solution 612.

As shown at point G, the analysis assembly 300 may be removed from the third analysis vessel 610, allowed to drain, and, if desired, dried using a heater 614, or other device. In some examples, the analysis assembly 300 may remain in the third analysis vessel 610, while the third preparation solution 612 is allowed to evaporate. This may be used, for example, to form the collapsed groups 206 discussed with respect to FIG. 2.

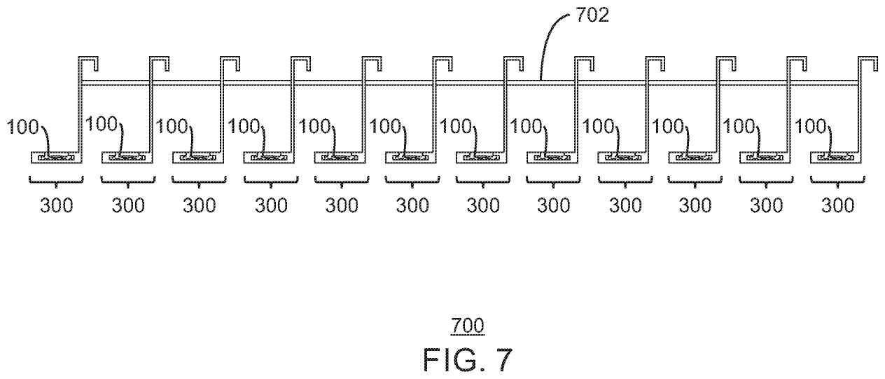

FIG. 7 is a drawing of an example of a caddy strip 700 of analysis assemblies 300 supporting multiple analysis chips 100. Like numbered items are as described with respect to FIGS. 1 and 3. This may be used for multiple simultaneous analysis, such as for simultaneous screening for compounds, nucleotides, bacterial signatures, viruses, and the like. To form the caddy strip 700, the analysis assemblies 300 may be joined to a bracket 702, for example, by being snapped onto the bracket 702 or by being manufactured with each analysis assembly 300 extending from the bracket 702. Spaces between each of the analysis assemblies 300 allow the analysis assemblies 300 to be inserted into different test vessels substantially simultaneously.

Other configurations may be envisioned. The bracket 702 may be formed from a polymeric material, such as a high-impact polystyrene, a polyacrylates, and the like. In some examples the bracket 702 may be formed from a metal, such as aluminum, which may allow the bracket 702 to be reusable. The analysis assemblies 300 used in the caddy strip 100 may be configured to hold multiple chips in each analysis assembly 300, for example, in stacked chip supporters 302 attached to the mounting assembly 304.

The analysis chips 100 in caddy strip 700 may be the same, for example, to perform the same analysis on a number of different solutions. In some examples, the analysis chips 100 or may each be of different types, for example, to perform a number of different analyses for the same solution. Any number of other combinations may be used.

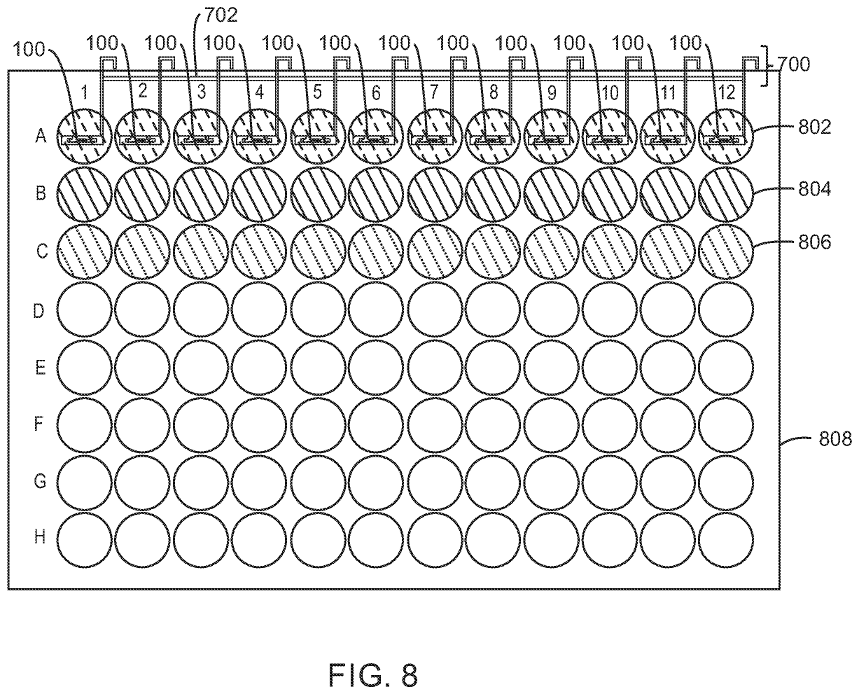

FIG. 8 is a schematic drawing of an example of a caddy strip 700 used to prepare multiple samples on analysis chips 100 simultaneously. In this example, the caddy strip is used to sequentially immerse twelve analysis chips 100 in different preparation solutions 802, 804, and 806 as the caddy strip 700 is moved between wells on a 96-well plate 808. The caddy strip 700 allows the twelve analysis chips 100 to be substantially simultaneously immersed in and removed from each of the preparation solutions 802, 804, and 806. The procedure may be as described with respect to FIG. 6, although in this example, multiple analysis chips 100 are prepared at the same time.

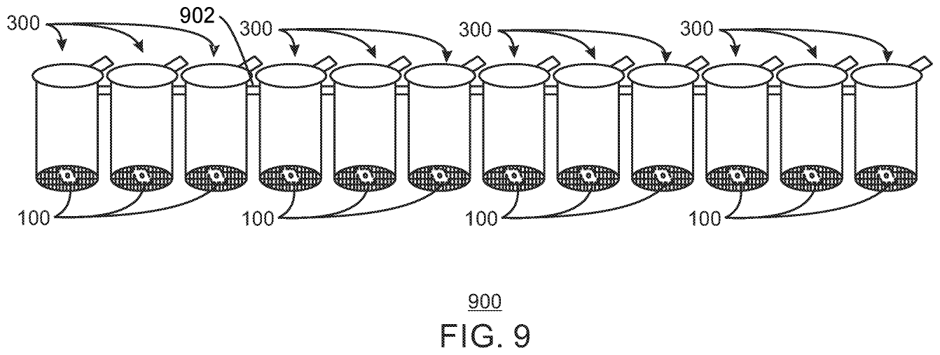

The analysis assemblies 300 used in a multiple test arrangement are not limited to the configuration shown. Other configurations, such as the open tube configuration described with respect to FIG. 5, may be used. This is described further with respect to FIG. 9.

FIG. 9 is a drawing of an example of a strip tube basket 900 supporting multiple analysis chips 100. Like numbered items are as described with respect to FIGS. 1 and 3. In this example, each of the analysis assemblies 300 have the cylindrical design described with respect to FIG. 5. The individual analysis assemblies 300 may be manufactured with bracket 902 holding them together or may be inserted into the bracket 902, for example, using a bracket 902 with round openings to hold the analysis assemblies 300. As described with respect to the bracket 702 of FIG. 7, the bracket 902 may be made from a polymeric material, or a metal, such as aluminum.

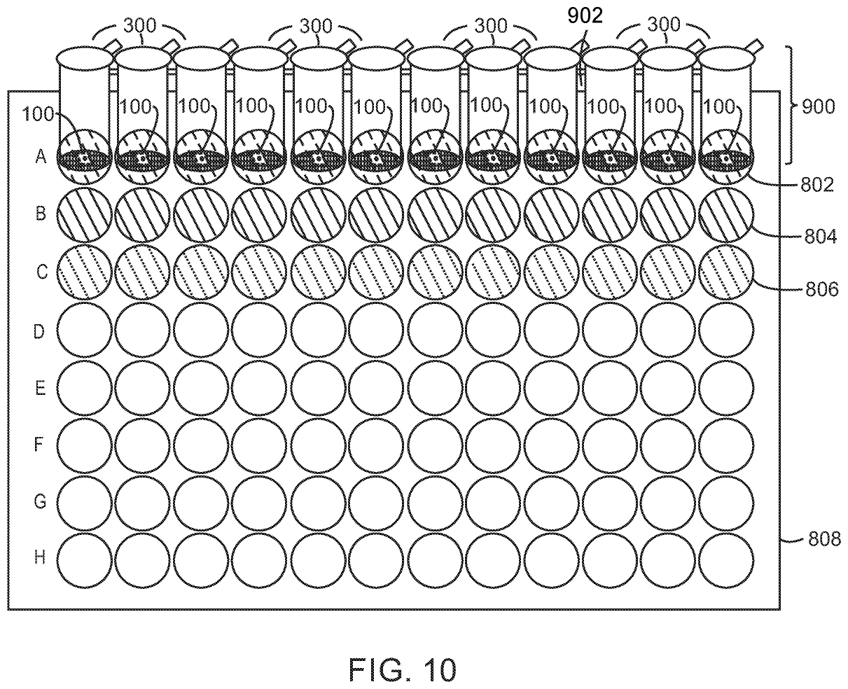

FIG. 10 is a schematic drawing of a strip tube basket 900 used to prepare multiple samples on analysis chips 100 simultaneously. Like numbered items are as described with respect to FIGS. 1, 3, and 8. As described with respect to FIG. 8, strip tube basket 900 may be used to prepare multiple samples, for example, using a 96-well plate 808, or similar multivolume test vessel.

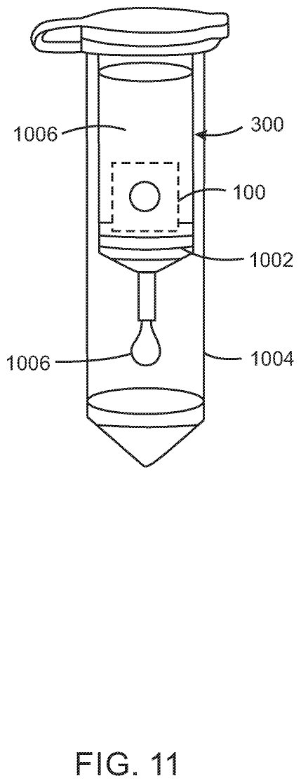

The analysis assembly 300 is not limited to the configurations described with respect to FIG. 3 or 5. Other analysis assemblies 300 may be used to support analysis chips 100, for example, as described with respect to FIG. 11.

FIG. 11 is a drawing of an example of an analysis assembly 300 that uses a column 1002 to support an analysis chip 100 in a test vessel 1004. In this example, the test vessel may be a micro-centrifuge tube, such as described with respect to FIGS. 4 and 5. The column 1002 may be used to control the rate of flow of a preparation solution 1006, which may also be used to control the incubation period that the solution is in contact with the analysis chip 100. For example, the column 1002 may allow a slow flow, such as a few milliliters a minute, without the exertion of extra pressure. The column 1002 may be selected to adjust the flow rate, and thus the contact time with the analysis chip 100. Depending on the flow rate of the column 1002 selected, the contact time may be about 5 minutes, 10 minutes, 30 minutes, or more. In other examples, the column 1002 may prevent flow unless some force is exerted above the column 1002, such as using a syringe or a centrifuge, among others.

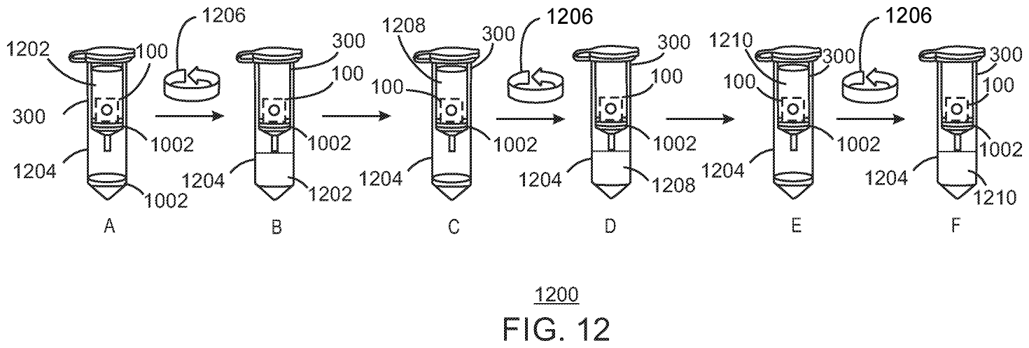

FIG. 12 is a schematic drawing of an example of a method 1200 for preparing a sample on an analysis chip 100 supported by an analysis assembly 300 including a column 1002. Like numbered items are as described with respect to FIGS. 1, 3, and 10. The method 1200 may begin at point A, when a preparation solution 1202 is added to the analysis assembly 300 over the analysis chip 100. After a suitable incubation period, for example, about 1 minute, about 5 minutes, or longer, the test vessel 1204 may be centrifuged 1206, forcing the preparation solution 1202 through the column 1002 and into the test vessel 1204, as shown at point B.

The preparation solution 1202 may be emptied from the test vessel 1204, and, as shown at point C, a second preparation solution 1208 may be added to the analysis assembly 300. After an incubation period, the test vessel 1204 may be centrifuged 1206, forcing the second preparation solution 1208 through the column 1002 and into the test vessel, as shown at point D.

The second preparation solution 1208 may then be emptied from the test vessel 1204, and, as shown at point E, a third preparation solution 1210 may be added to the analysis assembly 300. After an incubation period, the test vessel 1204 may be centrifuged 1206, forcing the third preparation solution 1210 through the column 1002 and into the test vessel, as shown at point E.

The method 1200 may include more or fewer cycles of preparation solution and centrifugation, depending on the chemistry of the techniques chosen. Further, once the preparation is complete, the analysis assembly 300 may be removed from the test vessel 1204 and the analysis chip 100 may be dried for analysis.

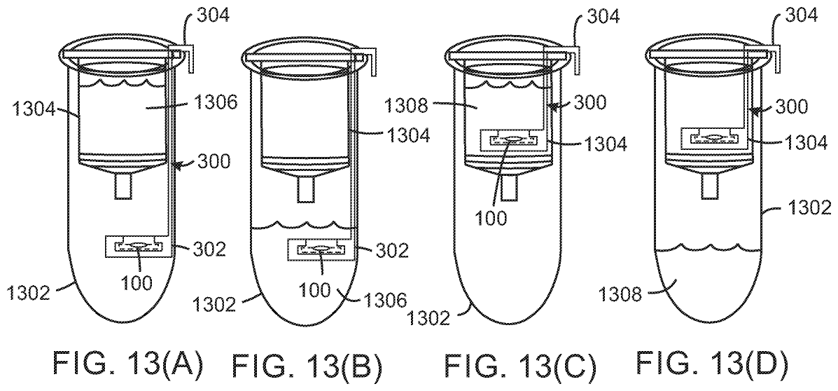

FIGS. 13(A) through 13(D) are schematic diagrams indicating the use of an analysis assembly 300 in a test vessel 1302 and column 1304. Like numbered items are as described with respect to FIGS. 1 and 3. As shown in FIG. 13(A), the analysis assembly 300 may support an analysis chip 100 under a column 1304. For example, the column 1304 may be used to filter solids or other materials from a test solution 1306. As shown in FIG. 13(B), after centrifuging, the test solution 1306 may be forced through the column 1304 into the lower region of the test vessel 1302, exposing the analysis chip 100 to the test solution 1306.

The analysis assembly 300 may be used to insert the analysis chip 100 into a column 1304, as shown in FIG. 13(C). A preparation solution 1308 may be added to the column 1304 over the analysis chip 100. After incubation, centrifuging the test vessel 1302 may force the solution 1308 through the column 1304 and into the lower region of the test vessel 1302.

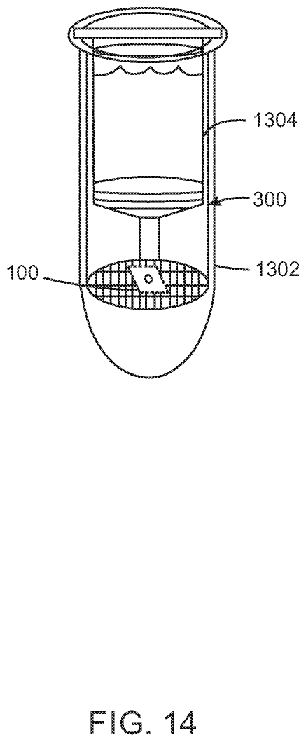

The arrangements shown in FIGS. 13(A) through 13(D) are not limited to the analysis assembly 300 shown in the figures, but may be used with any number of other configurations. For example, the tubular analysis assembly 300 shown in FIG. 5 may be used, as described with respect to FIG. 14.

FIG. 14 is a drawing of an analysis assembly 300 supporting an analysis chip 100 used in a test vessel 1302 with a column 1304. Like numbered items are as described with respect to FIGS. 1, 3, and 13.

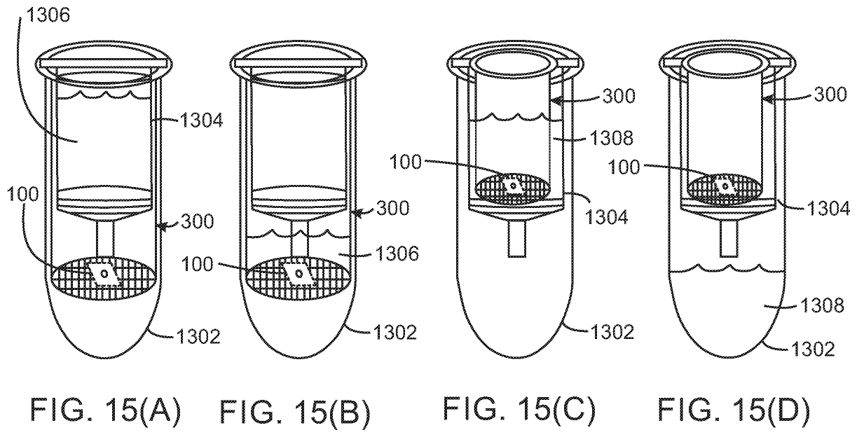

FIGS. 15(A) through 15(D) are schematic diagrams indicating the use of an analysis assembly 300 in a test vessel 1302 and column 1304. Like numbered items are as described with respect to FIGS. 1, 3, and 13. It may be noted for both FIGS. 13 and 15 that differently sized analysis assemblies 300 may be used, for example, with longer analysis assemblies 300 used for FIGS. 13(A) and (B), and 15(A) and (B), and shorter analysis assemblies 300 used for FIGS. 13(C) and (D), and 15(C) and (D).

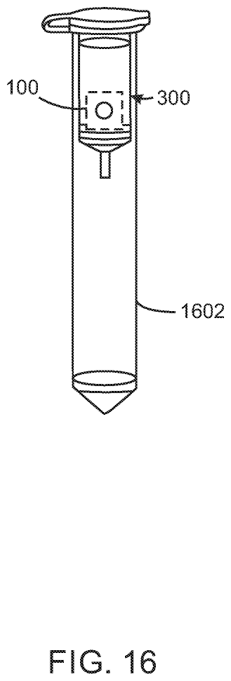

In the schematic diagrams of FIGS. 13 and 15, the solution is emptied from the test vessel 1302 after every centrifugation. A larger test vessel may be designed to hold multiple increments of test fluids as described with respect to FIG. 16.

FIG. 16 is a drawing of an analysis assembly 300 supporting an analysis chip 100 used in a test vessel 1602 that can hold multiple increments of test fluids. Like numbered items are as described with respect to FIGS. 1 and 3.

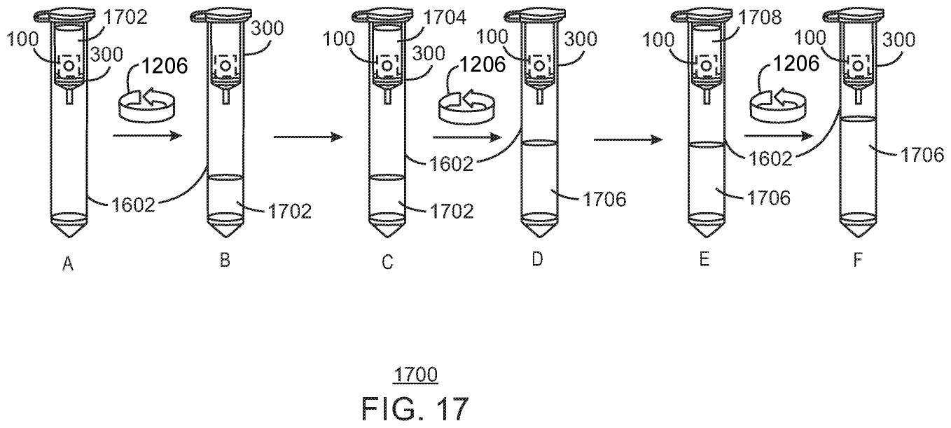

FIG. 17 is a schematic drawing of an example of a method 1700 for preparing a sample on analysis chip 100 supported by an analysis assembly 300 in a larger test vessel 1602 that can hold multiple increments of test fluids. Like numbered items are as described with respect to FIGS. 1, 3, and 16. The method 1700 may begin at point A, when a preparation solution 1702 is added to an analysis assembly 300 and a larger test vessel 1602. After a suitable incubation period, the larger test vessel 1602 is centrifuged 1206 forcing the test solution 1702 to flow out of the analysis assembly 300 and collect at the bottom of the larger test vessel 1602, as shown at point B.

At point C, a second preparation solution 1704 may be added to the analysis assembly 300. After incubation, the larger test vessel 1602 is centrifuged 1206, forcing the second preparation solution 1702 to flow out of the analysis assembly 300, and be collected as a mixture 1706 at the bottom of the larger test vessel 1602, as shown at point D.

At point E, a third preparation solution 1708 may be added to the analysis assembly 300. After incubation, the larger test vessel 1602 is again centrifuged 1206, forcing the third test solution 1708 to flow out of the analysis assembly 300, and be collected with the mixture 1706 at the bottom of the larger test vessel 1602, as shown at point F.

As described herein, fewer or greater numbers of stages may be used in the preparation. Further, once the solutions have been completed, the analysis assembly 300 may be removed from the larger test vessel 1602. The analysis chip 100 may be left in the analysis assembly 300 during drying, or removed for processing.

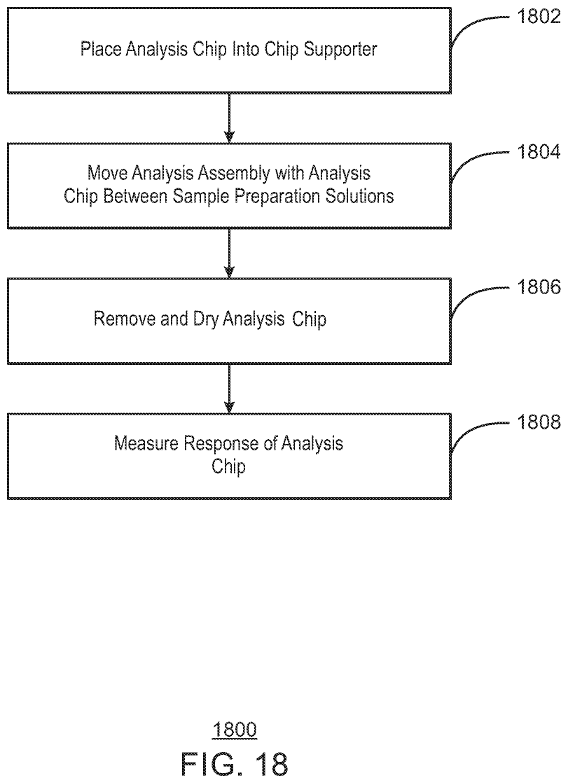

FIG. 18 is a process flow diagram of a method 1800 for preparing a sample on an analysis chip supported by an analysis assembly. The method may begin at block 1802 when an analysis chip is placed into a chip supporter. As described herein, the analysis chip may be slid into a slot on the chip supporter, placed or mounted to a mesh that is the chip supporter, or placed on top of a column, among others.

The analysis assembly with the analysis chip may be moved between sample preparation solutions, as indicated at block 1804. In some examples, sample preparation solutions may be applied above the analysis chip in the analysis assembly, and the analysis assembly centrifuged to force the preparation solution to flow out of the analysis assembly.

Once the treatment with the preparation solutions is completed, at block 1806, the analysis chip may be removed and dried. As described herein, this may be performed by pulling the analysis assembly out and drying the analysis chip in place in the analysis assembly. In some examples, the analysis chip is removed from the analysis assembly before drying.

At block 1808, the response of the analysis chip to the analytes in the preparation solutions may be measured. This may be performed using a spectroscopic technique, for example, including surface enhanced luminescence techniques, such as surface enhanced Raman spectroscopy, among others. Other techniques that may be used include fluorimetry, transflectance, calorimetry, or electrochemical techniques, among others.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the scope of the present techniques.

What is claimed is:

1. An analysis assembly, comprising:
an analysis chip disposed on a supporting platform aligned in an x-y plane, wherein an active surface of the analysis chip is aligned along a z-axis opposite the supporting platform; and
a mounting assembly joined to the supporting platform, wherein the mounting assembly is configured to hold the analysis chip in an analysis vessel, and wherein the z-axis is in alignment with a longitudinal axis of the analysis vessel.

2. The analysis assembly of claim 1, wherein the active surface of the analysis chip comprises a plurality of flexible columnar structures, wherein each flexible columnar structure comprises a metal cap.

3. The analysis assembly of claim 1, wherein the analysis chip is configured for a surface enhanced luminescence analysis.

4. The analysis assembly of claim 1, wherein the supporting platform comprises a slot parallel to the x-y plane configured to hold the analysis chip.

5. The analysis assembly of claim 1, wherein the supporting platform comprises a mesh.

6. The analysis assembly of claim 1, wherein the mounting assembly comprises a mounting assembly comprising a L shape configured to engage a lip of a test vessel to support the supporting platform within the test vessel.

7. The analysis assembly of claim 1, wherein the mounting assembly comprises an open cylinder with the supporting platform disposed at one end of the open cylinder and a lip disposed at an opposing end of the open cylinder, wherein an outer diameter of the open cylinder is lower than an inner diameter of a test vessel, and wherein the lip is configured to engage an opening of the test vessel and support the mounting assembly.

8. The analysis assembly of claim 1, comprising a caddy strip comprising a plurality of mounting assemblies, wherein spaces between each of the plurality of mounting assemblies allows the plurality of mounting assemblies to be inserted into a plurality of test vessels substantially simultaneously.

9. The analysis assembly of claim 1, wherein the supporting platform comprises a filter.

10. A method for preparing a sample on an analysis chip for spectroscopic analysis, comprising:
immersing the analysis chip held in a chip supporter in an analysis assembly in a plurality of sample preparation solutions in a sequential fashion;
removing the analysis assembly with the analysis chip from a final preparation solution;
drying the analysis chip; and
performing a spectroscopic measurement on the analysis chip.

11. The method of claim 10, comprising placing the analysis chip into a slot on the chip supporter.

12. The method of claim 10, removing the analysis chip from the chip supporter prior to drying the analysis chip.

13. The method of claim 10, comprising performing the spectroscopic measurement on the analysis chip while the analysis chip is held in the chip supporter.

14. A system for surface-enhanced Raman spectroscopy (SERS), comprising:
a SERS analysis chip comprising an active surface comprising a plurality of collapsed groups on a substrate, wherein:
each collapsed group comprises at least two flexible columnar structures; and
each flexible columnar structure comprises a metal cap;
a supporting platform for the SERS analysis chip that is aligned in an x-y plane, wherein the active surface is aligned along a z-axis opposite the supporting platform; and
a mounting assembly joined to the supporting platform, wherein the mounting assembly is configured to hold the SERS analysis chip in an analysis vessel, and wherein the z-axis is in alignment with a longitudinal axis of the analysis vessel.

15. The system of claim 14, wherein a collapsed group comprises a plurality of adsorbed analyte molecules on the metal caps of each of the flexible columnar structures.
